(19) United States
(12) Patent Application Publication
(10) Pub. No.: US 2014/0006386 A1
(43) Pub. Date: Jan. 2, 2014

(54) SYSTEM FOR CREATING A UNIFIED CLOTHING FILE

(71) Applicant: SeungWoo Oh, Koyang (KR)

(72) Inventor: SeungWoo Oh, Koyang (KR)

(73) Assignee: CLO VIRTUAL FASHION INC., Seoul (KR)

(21) Appl. No.: 13/536,511

(22) Filed: Jun. 28, 2012

(51) Int. Cl. G06F 17/30

(52) U.S. Cl. CPC G06F 17/30115
USPC 707/722

(57) ABSTRACT

Embodiments of the present invention provide an approach for providing a clothing system for creating a unified clothing file for actual clothing and virtual avatar clothing associated with a user. Specifically, in a typical embodiment, an avatar may be associated with the user. The user may select a real clothing item which can be worn by the user. Also, the user may select a virtual clothing item which may be worn or used by the user's avatar. The real clothing item and the virtual clothing item are encoded with the same identification code. A unified clothing file entry associated with the clothing items may be stored in the unified clothing file.

### TECHNICAL FIELD

In general, embodiments of the present invention provide an approach for providing a clothing system. Specifically, embodiments of the present invention relate to an approach for providing a clothing system for creating a unified clothing file for actual clothing and virtual avatar clothing.

### BACKGROUND

A virtual world is an online community that takes the form of a computer-based simulated environment through which users can interact with one another and use and create objects. Online, internet accessible virtual worlds have become increasingly popular, as personal computers have grown in power and become widely affordable, and high-speed internet access has become commonplace. The term “virtual world” has become largely synonymous with interactive three-dimensional (3D) virtual environments, where the users take the form of avatars visible to others.

In many virtual worlds, the avatars are able to mimic the actions of real people in many ways, such as by looking in different directions, moving to different locations, entering buildings, handling objects, and even interacting with other avatars. Interactions between avatars can include speaking, showing facial expressions, and using movements to display a range of feelings and emotions, for example by drooping over to indicate illness, shedding tears to show sadness, or jumping around to show joy or excitement. Generally, an avatar functions as an extension of its user, by going where the user directs, looking where the user wishes to look, and expressing emotions which reflect the emotions of the users. Typically, users are able to customize body shape, gender, facial features, hair style, and clothing. In some instances, a user may purchase one or more clothing items for an avatar from an avatar marketplace.

Similarly, a person may purchase one or more clothing items for himself/herself using an online marketplace. Convenience is a great advantage to online shopping. Shopping online is generally quite easy; a person can simply sit in front of the computer and click around, from one site to another. Also, online clothes shopping may provide the chance to browse for diverse items in different stores at the same time, with a wide range of clothing choices to select from.

However, there is no clothing system for creating a unified clothing file for actual clothing for a user and virtual avatar clothing. Heretofore, several unsuccessful attempts have been made to address these shortcomings.

U.S. Pat. No. 7,808,385 discloses an interactive clothing system which allows a user to interact with an article of clothing.

U.S. Patent Application 20080262944 discloses an online clothing display system including a dressed mannequin, a rotating platform, and image recorder, and a mainframe.

U.S. Patent Application 20090260123 discloses a clothing system having a plurality of different clothing articles that are designed to be used with interactive decorative elements.

U.S. Pat. No. 7,742,901 discloses a method and system for analyzing and/or generating object models, and in particular to generating object models of a second type using object models of the first type.

U.S. Patent Application 20070273711 discloses a unique 3D graphics system and method that allows participants to change their avatar's clothes by constructing a new avatar consisting of multiple models including the basic nude model and all of its parts, all the clothing models, and hair models and any other models that might be required.

U.S. Patent Application 20050137015 discloses a system and method for that allows for a role-playing game having a customizable avatar and differentiated instant message environment.

None of these references, however, teach a clothing system for creating a unified clothing file for actual clothing for a user and virtual avatar clothing.

### SUMMARY

In general, embodiments of the present invention provide an approach for providing a clothing system for creating a unified clothing file for actual clothing and virtual avatar clothing associated with a user. Specifically, in a typical embodiment, an avatar may be associated with the user. The user may select a real clothing item which can be worn by the user. Also, the user may select a virtual clothing item which may be worn or used by the user's avatar. The real clothing item and the virtual clothing item are encoded with the same identification code. A unified clothing file entry associated with the clothing items may be stored in the unified clothing file.

As used herein, the unified clothing file may be of any suitable format including XML documents, flat files, CSV files, SQL tables, relational database tables, and others. The unified clothing file entry may be any suitable entry in the unified clothing file.

In one example, the identification code may be a two-dimensional barcode that includes at least one of a PDF417 code, an Aztec code, a quick response (QR) code, a codablock code, a code 1, a code 16K, a code 49, a CP code, a data glyph code, a datastrip code, a dot code A, a maxicode code, a minicode code, a smartcode code, a supercode code, a snowflake code, an ultracode code, a paperdisk code, or a reduced space symbology code. In a second example, the identification code may be a serial number, such as a serial number that represents a specific clothing item from a specific brand. In other examples, the identification code may be another code or value.

A first aspect of the present invention provides a method for creating a unified clothing file, comprising: associating an avatar with a user; selecting a first clothing item associated with the user; selecting a second clothing item, wherein the second clothing item is a virtual clothing item; encoding the first clothing item and the second clothing item with an identification code; and storing a unified clothing file entry associated with the first clothing item and the second clothing item using the identification code.

A second aspect of the present invention provides a system for creating a unified clothing file, comprising: a memory medium comprising instructions; a bus coupled to the memory medium; and an unified clothing processing tool coupled to the bus that when executing the instructions causes the system to: associate an avatar with a user; select a first clothing item associated with the user; select a second clothing item, wherein the second clothing item is a virtual clothing item; encode the first clothing item and the second clothing item with an identification code; and store a unified clothing file entry associated with the first clothing item and the second clothing item using the identification code.

A third aspect of the present invention provides a computer program product for creating a unified clothing file, the computer program product comprising a computer readable storage medium, and program instructions stored on the computer readable storage medium, to: associate an avatar with a user; select a first clothing item associated with the user; select a second clothing item, wherein the second clothing item is a virtual clothing item; encode the first clothing item and the second clothing item with an identification code; and store a unified clothing file entry associated with the first clothing item and the second clothing item using the identification code.

A fourth aspect of the present invention provides a method for deploying a system for creating a unified clothing file, comprising: providing a computer infrastructure being operable to: associate an avatar with a user; select a first clothing item associated with the user; select a second clothing item, wherein the second clothing item is a virtual clothing item; encode the first clothing item and the second clothing item with an identification code; and store a unified clothing file entry associated with the first clothing item and the second clothing item using the identification code.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computerized implementation of the present invention according to an embodiment of the present invention.

FIG. 2 shows a more detailed view of an example unified clothing processing tool according to an embodiment of the present invention.

FIG. 3 shows an example process for simulating a three-dimensional (3D) clothed avatar according to an embodiment of the present invention.

FIG. 4 shows representations of example avatars of various shapes and sizes according to an embodiment of the present invention.

FIG. 5 shows a method flow diagram for creating a unified clothing file according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Embodiments of the present invention provide an approach for providing a clothing system for creating a unified clothing file for actual clothing and virtual avatar clothing associated with a user. Specifically, in a typical embodiment, an avatar may be associated with the user. The user may select a real clothing item which can be worn by the user. Also, the user may select a virtual clothing item which may be worn or used by the user's avatar. The real clothing item and the virtual clothing item are encoded with the same identification code. A unified clothing file entry associated with the clothing items may be stored in the unified clothing file.

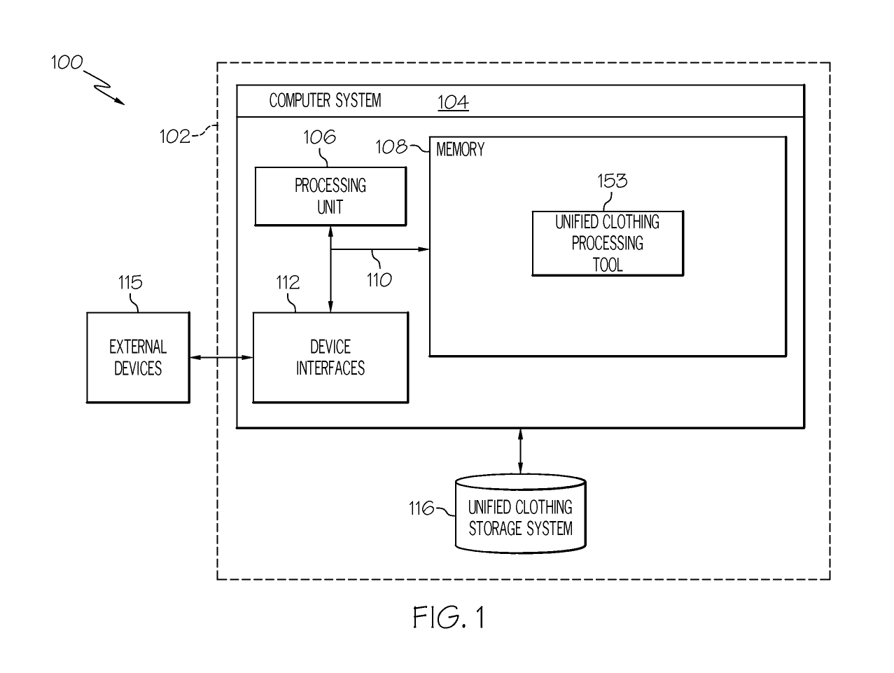

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for creating a unified clothing file. It should be understood that any other computers implemented under the present invention may have different components/software, but will perform similar functions. As shown, computer system 104 includes a processing unit 106, memory 108 for storing an unified clothing processing tool 153, a bus 110, and device interfaces 112.

Processing unit 106 collects and routes signals representing outputs from external devices 115 (e.g., a keyboard, a pointing device, a display, a graphical user interface, etc.) to unified clothing processing tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating unified clothing processing tool 153, which is stored in memory 108 and/or unified clothing storage system 116. While executing computer program code, processing unit 106 can read and/or write data to/from memory 108. Unified clothing storage system 116 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

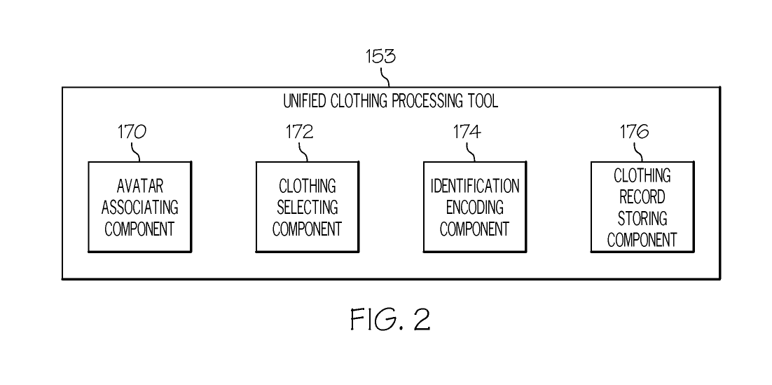

FIG. 2 shows a more detailed view of an example unified clothing processing tool 153. Unified clothing processing tool 153 includes an avatar associating component 170, clothing selecting component 172, identification encoding component 174, and clothing record storing component 176.

Avatar associating component 170 may associate an avatar with a user. Clothing selecting component 172 may select a first clothing item associated with the user and a second clothing item associated with the avatar. Identification encoding component 174 may encode the first clothing item and the second clothing item with an identification code. The clothing record storing component 176 may store a unified clothing file entry associated with the first clothing item and the second clothing item using the identification code.

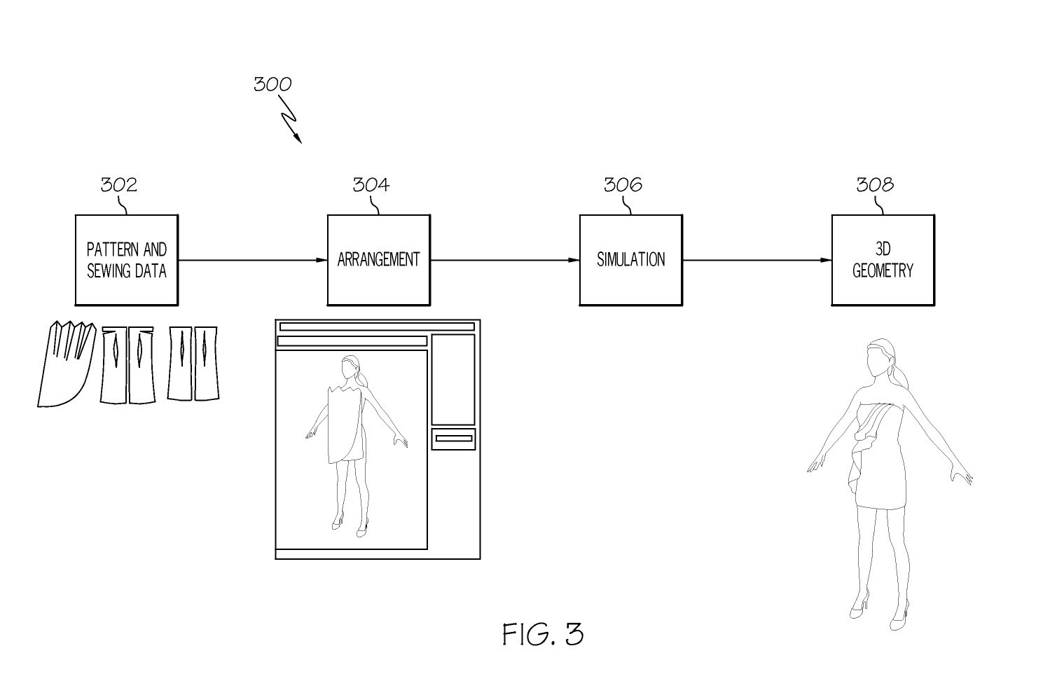

FIG. 3 shows an example process for simulating a three-dimensional (3D) clothed avatar according to an embodiment of the present invention. In one example, the user may wish to view the avatar wearing a certain clothing item or items. In a second example, the clothing item (e.g., handbag or hat) may not be associated with a specific avatar. Any number of virtual clothing items may be generated based on a respective actual clothing item that has been selected by the user. Pattern and sewing data 302 may define each clothing item. Pattern and sewing data 302 may include a certain pattern(s), textile combinations (i.e., any type of cloth or woven fabric combination), and the like. A clothing item may include any object having pattern and/or sewing data, such as shirts, pants, coats, jackets, dresses, skirts, handbags, purses, hats, footwear, accessories, and the like. In one example, a design feature may be used to design a clothing item. In other examples, the user may select from pre-defined clothing items. An arrangement 304 may be selected by the user when clothing the avatar. The arrangement 304 may include any number of clothing items and any number of types of clothing items (e.g., blue blouse, white skirt, red shoes, striped socks, etc.). Simulation 306 may generate a 3D geometry 308 (or 3D avatar image) which illustrates the avatar wearing the selected arrangement. In one example, the avatar clothing items may be tailored to the physical appearance of the avatar (shape, size, etc.).

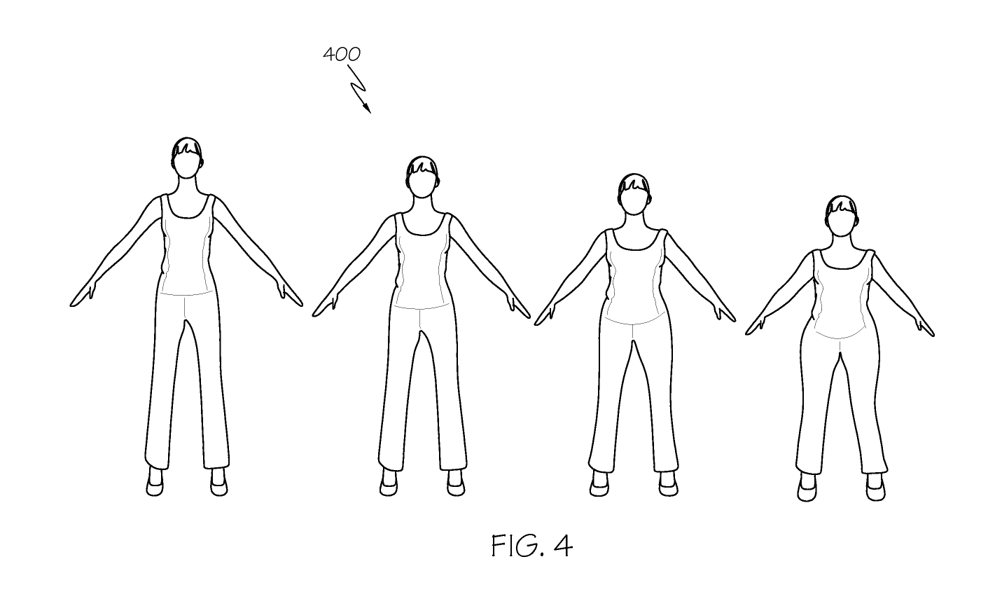

FIG. 4 shows representations of example avatars 400 of various shapes and sizes according to an embodiment of the present invention. Like people, avatars may be created in various shapes, sizes, skin tones, and the like. Typically, the avatar is the graphical representation of the user or the user's alter ego or character. The avatar may take either a three-dimensional form or a two-dimensional form. In one example, the avatar may be a three-dimensional graphical representation of the user. In this case, when the user clothes the avatar in selected clothing items, the user will get an idea of how the actual clothing items associated with the virtual clothing items will look when worn by the user.

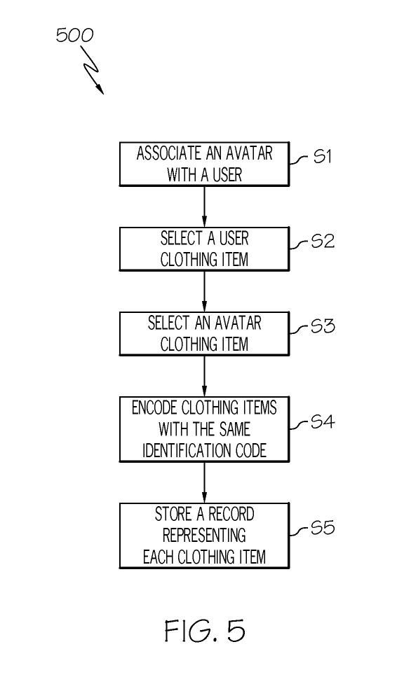

FIG. 5 shows a method flow diagram for creating a unified clothing file according to an embodiment of the present invention. At S1, associating an avatar is associated with a user. At S2, a first clothing item associated with the user is selected by the user. At S3, a second clothing item associated with the avatar is selected. At S4, the first clothing item and the second clothing item are encoded with an identification code. At S5, a unified clothing file entry associated with the first clothing item and the second clothing item is stored using the identification code. It should be noted that, in some alternative implementations, the functions noted in the blocks may occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Further, it can be appreciated that the methodologies disclosed herein can be used within a computer system to provide a unified clothing service, as shown in FIG. 1. In this case, unified clothing processing tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage medium including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage medium” and “communications media.”

“Computer storage medium” include volatile and non-volatile, removable and non-removable media implemented in any method or technology for storage of information such as computer readable instructions, data structures, program modules, or other data. Computer storage medium includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for estimating the accuracy of a transcription of a voice recording. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for creating a unified clothing file, comprising:
associating an avatar with a user;
selecting a first clothing item associated with the user;
selecting a second clothing item, wherein the second clothing item is a virtual clothing item;
encoding the first clothing item and the second clothing item with an identification code; and
storing a unified clothing file entry associated with the first clothing item and the second clothing item using the identification code.

2. The computer-implemented method of claim 1, wherein the identification code comprises one of a two-dimensional barcode or serial number.

3. The computer-implemented method of claim 1, wherein the first clothing item is associated with pattern and sewing data.

4. The computer-implemented method of claim 3, wherein the pattern and sewing data comprises at least one of a pattern or a textile combination.

5. The computer-implemented method of claim 1, wherein the second clothing item is generated based on the first clothing item.

6. The computer-implemented method of claim 1, wherein second clothing item is associated with a pattern and sewing data.

7. The computer-implemented method of claim 1, second clothing item is associated with an avatar.

8. A system for creating a unified clothing file, comprising:
a memory medium comprising instructions;
a bus coupled to the memory medium; and
an unified clothing processing tool coupled to the bus that when executing the instructions causes the system to:
associate an avatar with a user;
select a first clothing item associated with the user;
select a second clothing item, wherein the second clothing item is a virtual clothing item;
encode the first clothing item and the second clothing item with an identification code; and
store a unified clothing file entry associated with the first clothing item and the second clothing item using the identification code.

9. The system of claim 8, wherein the identification code comprises one of a two-dimensional barcode or serial number.

10. The system of claim 8, wherein the first clothing item is associated with a pattern and sewing data.

11. The system of claim 10, wherein the pattern and sewing data comprises at least one of a pattern or a textile combination.

12. The system of claim 8, wherein the second clothing item is generated based on the first clothing item.

13. The system of claim 8, wherein second clothing item is associated with a pattern and sewing data.

14. The system of claim 8, second clothing item is associated with an avatar.

15. A computer program product for creating a unified clothing file, the computer program product comprising a computer readable storage medium, and program instructions stored on the computer readable storage medium, to:
associate an avatar with a user;
select a first clothing item associated with the user;
select a second clothing item, wherein the second clothing item is a virtual clothing item;
encode the first clothing item and the second clothing item with an identification code; and
store a unified clothing file entry associated with the first clothing item and the second clothing item using the identification code.

16. The computer program product of claim 15, wherein the identification code comprises one of a two-dimensional barcode or serial number.

17. The computer program product of claim 15, wherein the first clothing item is associated with a pattern and sewing data.

18. The computer program product of claim 17, wherein the pattern and sewing data comprises at least one of a pattern or a textile combination.

19. The computer program product of claim 15, wherein the second clothing item is generated based on the first clothing item.

20. The computer program product of claim 15, wherein second clothing item is associated with a pattern and sewing data.

21. The computer program product of claim 15, second clothing item is associated with an avatar.

22. A method for deploying a system for creating a unified clothing file, comprising:
providing a computer infrastructure being operable to:
associate an avatar with a user;
select a first clothing item associated with the user;
select a second clothing item, wherein the second clothing item is a virtual clothing item;
encode the first clothing item and the second clothing item with an identification code; and
store a unified clothing file entry associated with the first clothing item and the second clothing item using the identification code.
